(19) United States
(12) Patent Application Publication
(10) Pub. No.: US 2006/0158680 A1
(43) Pub. Date: Jul. 20, 2006

(54) Printer system, recording medium and install method

(75) Inventors: Osamu Fujinawa, Niigata (JP); Naoki Shigeno, Niigata (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/187,021

(22) Filed: Jul. 22, 2005

(30) Foreign Application Priority Data
Jan. 20, 2005 (JP) 2005-012818

(51) Int. Cl. G06F 3/12

(52) U.S. Cl. 358/1.15; 358/1.13

(57) ABSTRACT

A printer system comprises a superordinate apparatus in which a printer driver and firmware are installed; a printer that downloads the firmware from the superordinate apparatus to store the same in a memory, the printer being controlled based on the firmware stored in the memory, wherein the superordinate apparatus comprises an install controller that controls installation of the firmware in association with installation of the printer driver.

### BACKGROUND OF THE INVENTION

1. Field of the Invention

The present invention relates to a printer system having a superordinate apparatus in which a printer driver and firmware are installed and a printer that downloads the firmware from the superordinate apparatus to store the same in a memory and is controlled based on the firmware stored in the memory. The present invention also relates to a recording medium for use with such printer system and to an install method. In particular, the present invention relates to a printer system, a recording medium and an install method designed to control the installation of firmware in association with the installation of the printer driver.

2. Description of the Related Art

An image forming apparatus such as a printer, a copy machine, and a multi-function printer typically has incorporated therein a group of control programs for control of its operation, that is, programs called firmware (printer control programs).

When an image forming operation is performed with such image forming apparatus, for example, operations of various components of the apparatus are controlled according to the firmware to form an image on paper or the like. The firmware may be stored by two different methods: a method of storing the firmware in a non-volatile memory inside the image forming apparatus, and another method of acquiring the firmware from a superordinate apparatus upon every activation of the image forming apparatus and storing the same in a volatile memory (ROM-less method).

In a place such as an office and a school where printing is performed by plural users, a print server (superordinate apparatus) is installed to establish a printing environment in which plural users can share an image forming apparatus (printer).

In such printing environment, a printer driver is preinstalled in the print server. Upon receiving a print instruction from a user, the instruction is converted by the print server into data interpretable by the printer (firmware) and the print data is transmitted to the printer to perform print processing.

In case of a ROM-less type printer, the printer is required to acquire firmware from the print server every time the printer is activated. This means that both the firmware and the printer driver have to be installed in the print server. It takes a great deal of trouble to install these programs separately

There have conventionally been proposed various techniques relating to such printer drivers and firmware. For example, Japanese Patent Application Publication No. 11-316662 describes a technique according to which firmware is rendered completely independent from a printer body so that all the print control programs and print fonts are provided to the printer in the form of printer driver software. As described in Japanese Patent Application Publication Nos. 11-175286 and 2001-27940, there have been known techniques of matching the versions of a printer driver and firmware.

According to the technique described in Japanese Patent Application Publication No. 11-316662, firmware, font data, and a printer driver are all provided in a same recording medium so that, if any trouble is found in the firmware, such trouble can be easily solved. The installment of these programs in the server eliminates the need of providing the printer with fixed firmware, and hence the firmware can be revised more easily.

According to this technique, therefore, the printer driver and the firmware are not installed at the same. Additionally, no consideration is given to convenience which would be realized if they were installed at the same time.

To install firmware, for example, it is necessary to create a folder with a certain name on a specific location on a server and to install the firmware in this folder.

According to the invention described in Japanese Patent Application Publication No. 11-316662 above, however, if the firmware is installed in a wrong location, or the folder is created with a wrong name, the printer will be unable, when acquiring the firmware from the server, to find the location where the firmware is stored, unable to acquire the firmware, and eventually unable to implement a printing job. This is a fatal defect for the printer.

According to the techniques described in Japanese Patent Application Publication Nos. 11-175286 and 2001-27940, when existing printer driver and firmware versions are to be upgraded, only the new version of the printer driver is provided, whereby the firmware also can be upgraded. However, like the technique of Japanese Patent Application Publication No. 11-316662 above, these techniques do not install the printer driver and the firmware at the same time.

According to these conventional techniques, therefore, even though the consistency between the printer driver and firmware versions can be ensured, the printer is unable to implement a printing job if the firmware is installed in a wrong storage location.

### SUMMARY OF THE INVENTION

The present invention has been made in view of the above circumstances and provides a printer system, a recording medium and an install method which are designed to install a printer driver and firmware at the same time by controlling the installation of the firmware in association with the installation of the printer driver.

According to an aspect of the present invention, a printer system comprises a superordinate apparatus in which a printer driver and firmware are installed; a printer that downloads the firmware from the superordinate apparatus to store the same in a memory, the printer being controlled based on the firmware stored in the memory, wherein the superordinate apparatus comprises an install controller that controls installation of the firmware in association with installation of the printer driver.

With the above configuration, the printer driver and the firmware are installed at the same time by controlling the installation of the firmware in association with the installation of the printer driver. This eliminates the need of troublesome operation of installing them separately, and prevents the problem that the storage location of the firmware cannot be found and the printer cannot be activated.

Further, the folder to store the firmware can be set as desired. Therefore, the present invention can solve the conventional problem that it is difficult to know the role of a folder from a default folder name or storage location thereof.

It is also possible to perform an operation linking the printer driver and the firmware together, for example an operation of checking the storage location of the firmware from the printer driver. Therefore, the storage location of the firmware can be easily known after installation thereof.

Even if a trouble occurs or a version is to be upgraded in either the printer driver or the firmware after installation thereof, the latest versions of the printer driver and firmware can be installed at the same time to maintain the consistency between them. Accordingly, it is possible to avoid problems which would be caused by version inconsistency.

### BRIEF DESCRIPTION OF THE DRAWINGS

Embodiment of the present invention will be described in detail based on the following figures, wherein:

FIG. 1 illustrates an example of overall configuration of a printer system according to the present invention;

FIG. 2 is a block diagram showing a part of the functional configuration of an install program recorded in a recording medium 10;

FIG. 3 illustrates a system configuration of a superordinate apparatus 20 and a printer 30;

FIG. 4 illustrates an example of an installation screen displayed during installation;

FIG. 5 illustrates an example of a property screen of a printer driver 14a;

FIG. 6 is a flowchart illustrating install processing according to the present invention; and

FIG. 7 illustrates a modification of the printer system according to the present invention.

### DESCRIPTION OF THE EMBODIMENT

Embodiment of a printer system, a recording medium and an install method according to the present invention will now be described in detail with reference to the accompanying drawings.

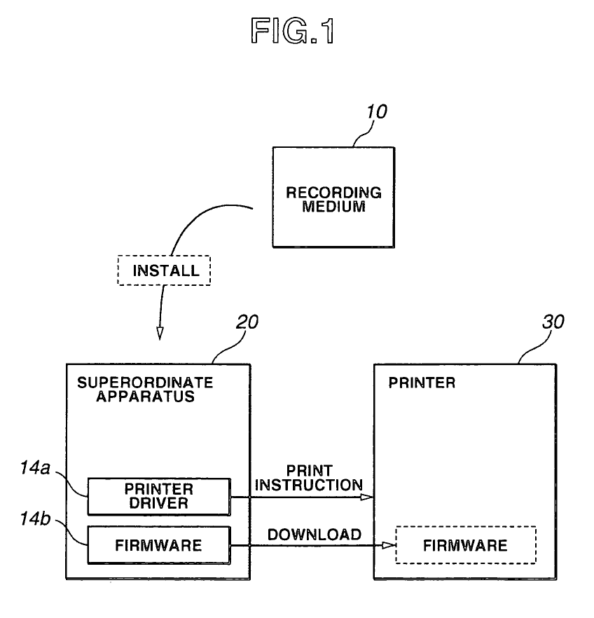

FIG. 1 shows an example of an overall configuration of a printer system according to the present invention. The printer system is composed of a superordinate apparatus 20 and a printer 30. A recording medium 10 has recorded therein programs including a printer driver 14a and firmware 14b. These programs are to be installed in the superordinate apparatus 20.

The following description of the embodiment will be made in terms of a case where the superordinate apparatus 20 and the printer 30 are connected directly. However, the connection method is not limited to this as long as the functions of the present invention are implemented. The superordinate apparatus 20 and the printer 30 may be connected via a network such as LAN (Local Area Network), or WAN (Wide Area Network).

The recording medium 10 is a CD-ROM or the like having an install program recorded therein. The programs recorded in the recording medium 10 are installed in the superordinate apparatus 20 by a conventionally known operation. The recording medium 10 records programs including a printer driver 14a and firmware 14b, and the printer driver 14a and the firmware 14b can be installed at the same time by a necessary install operation. According to the conventional techniques, the printer driver 14a and the firmware 14b need be installed separately, which induces a problem that it takes a lot of trouble to install them.

The superordinate apparatus 20 is a print server or the like which receives a print instruction from a network (not shown) and performs print processing with the use of the printer 30 managed by the superordinate apparatus 20. There are installed, in the superordinate apparatus 20, the programs recorded in the recording medium 10 and including the printer driver 14a and the firmware 14b. When the printer 30 performs print processing, the printer driver 14a plays the role of converting the received data to data interpretable for the printer 30 (firmware), while the firmware 14b operates on the printer 30 to play the role of controlling the components of the printer 30.

The printer 30 which is an image forming apparatus forms an image on paper or the like based on the print instruction received from the superordinate apparatus 20. The printer 30 controls the operation of its components according to the firmware 14b to form the image on paper or the like. As described before, the printer 30 downloads the firmware 14b from the superordinate apparatus 20 every time it is activated, that is, the printer 30 is a ROM-less printer.

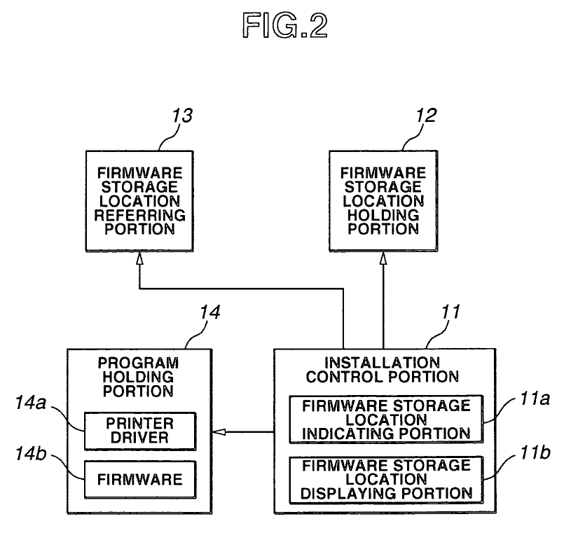

FIG. 2 is a block diagram showing a part of a functional configuration of an install program recorded in the recording medium 10.

The install program includes, as processing functional portions, an installation control portion 11, a firmware storage location holding portion 12, a firmware storage location referring portion 13, and a program holding portion 14.

The installation control portion 11 is a processing portion for controlling the install processing. Various processing functions that the install program has are implemented in a terminal (superordinate apparatus 20) to which the program is installed, according to the control by the installation control portion 11. More specifically, the functions to be realized by the firmware storage location holding portion 12 and the firmware storage location referring portion 13 other than the installation control portion 11, and the printer driver 14a and the firmware 14b held by the program holding portion 14 are installed in the superordinate apparatus 20.

The installation control portion 11 includes therein a firmware storage location indicating portion 11a and a firmware storage location displaying portion 11b.

The firmware storage location indicating portion 11a is a processing portion that indicates, when the firmware is installed, a folder name and a folder path to install the firmware. When a user enters his/her desired folder name or folder path, the firmware storage location indicating portion 11a changes the default setting to set the user's desired folder name and folder storage location.

The firmware storage location displaying portion 11b is a processing portion that displays, when the firmware is installed, the user's desired folder name and folder path indicated by the firmware storage location indicating portion 11a, on a display or the like.

The firmware storage location holding portion 12 is a processing portion that holds the storage location in which the firmware 14b is installed. More specifically, when the firmware 14b is installed in the superordinate apparatus 20, the firmware storage location holding portion 12 holds an absolute path that indicates which folder in the superordinate apparatus 20 the firmware 14b has been installed in. If the firmware storage location indicating portion 11a has changed the default setting during the installation of the firmware, the firmware storage location holding portion 12 holds the storage location after such change.

The firmware storage location referring portion 13 is a processing portion that displays the storage location where the firmware 14b is installed. Specifically, the firmware storage location referring portion 13 displays, on a display or the like, the firmware storage location held by the firmware storage location holding portion 12.

The program holding portion 14 is a processing portion that holds the printer driver 14a and the firmware 14b. The data including the printer driver 14a and the firmware 14b held in the program holding portion 14 is installed simultaneously by the installation control portion 11.

These are the descriptions of the processing functional portions of the install program recorded in the recording medium 10 according to the present invention. Although not shown in the drawing, the install program may further include an uninstallation control portion for erasing the data including the printer driver 14a and the firmware 14b.

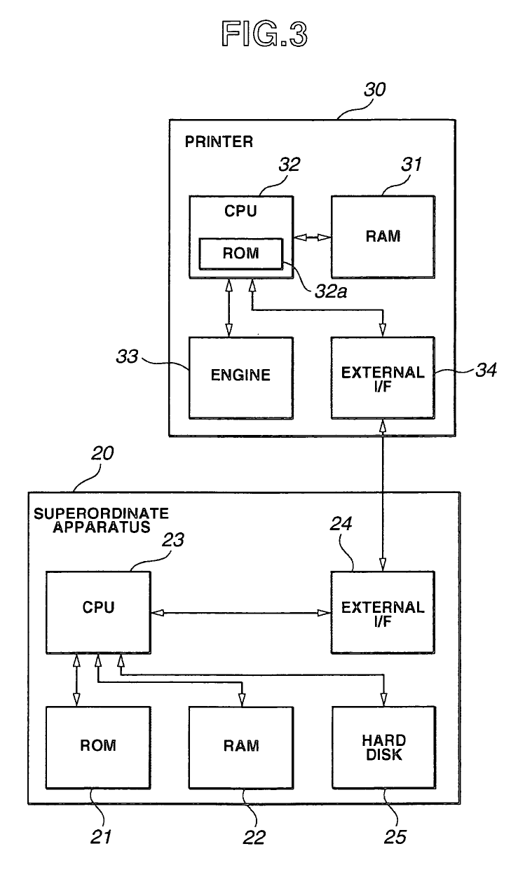

FIG. 3 shows a system configuration of the superordinate apparatus 20 and the printer 30 described above. The following description will be made only of the constituent elements relating to the present invention.

The superordinate apparatus 20 includes an ROM (Read Only Memory) 21 which is an area where the system information and so on are held, an RAM (Random Access Memory) 22 which is a working area where an application is executed, a CPU (Central Processing Unit) 23 for performing overall control of the superordinate apparatus 20, an external I/F (Interface) 24 which is an interface device for connecting the superordinate apparatus 20 and the printer 30, and a hard disk 25 for storing various data including an application and an operating system.

The CPU 23 is a processing unit that performs overall control of the superordinate apparatus 20. Upon the recording medium 10 being inserted in the superordinate apparatus 20, for example, the install program recorded in the recording medium 10 operates on this CPU 23. Specifically, the installation control portion 11 described above operates on the CPU 23 to control the install processing.

The hard disk 25 is a non-volatile storage device having characteristics that data therein is not erased when power is turned off. The hard disk 25 stores data including the printer driver 14a and the firmware 14b installed from the recording medium 10.

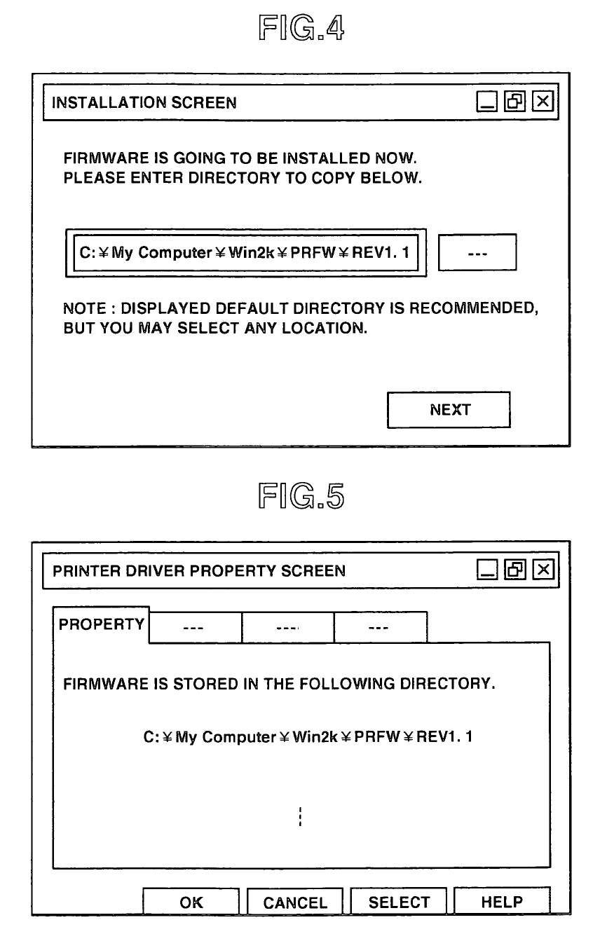

The superordinate apparatus 20 is further provided with a display (not shown), which displays an installation screen as shown in FIG. 4 when install processing is performed using the recording medium 10. If the user enters his/her desired folder name and storage location in response to the instruction on the screen, the firmware storage location indicating portion 11a changes the default setting. Further, as shown in FIG. 4, the folder name and storage location thus changed are displayed by the firmware storage location displaying portion 11b.

The storage location of the firmware 14b thus changed is held by the firmware storage location holding portion 12, and the firmware storage location holding portion 12 stores these data in the hard disk 25. Therefore, the data will not be erased but rather held even when the superordinate apparatus 20 is powered off.

Further, if the user wants to check the storage location of the firmware 14b after the installation thereof, the storage location of the firmware 14b can be checked by using a property screen of the printer driver 14a as shown in FIG. 5. This function is executed by the firmware storage location referring portion 13, and enables the user to easily find the location where the firmware 14b is stored.

On the other hand, the printer 30 includes an RAM 31 which is a working area for executing a program or the like, a CPU 32 for performing operation control and management of the components of the printer according to the program run on the RAM 31, an engine 33 that forms an image on paper or the like according to the control of the CPU 32, and an external I/F 34 which is an interface device for connecting the printer 30 and the superordinate apparatus 20.

The RAM 31 is an area which is temporarily used when executing a program or the like and data can be read from and written in the RAM 31. The RAM 31 is a volatile memory the data in which is erased when power is turned off. The firmware 14b downloaded from the superordinate apparatus 20 is stored and executed in the RAM 31.

The CPU 32 is a processing unit that performs overall control of the printer 30. Specifically, the processing function units forming the printer 30 operate according to instructions from the CPU 32. For example, the engine 33 is controlled according to the firmware 14b temporarily stored in the RAM 31 to form an image on paper or the like.

The CPU 32 also has an ROM 32a which is a non-volatile memory having characteristics that data can be electrically erased (rewritten), and data will not be erased even when power is turned off. The ROM 32a stores a download program having a function of receiving the firmware 14b from the superordinate apparatus 20 and executing the downloaded firmware 14b in the RAM 31.

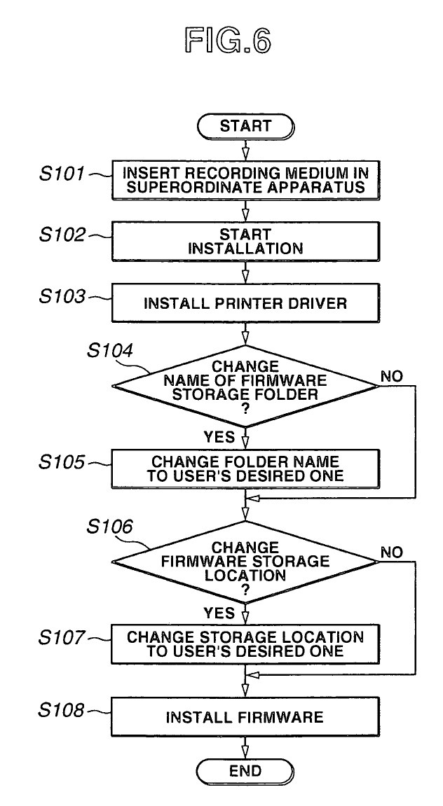

FIG. 6 is a flowchart illustrating the install processing according to the present invention.

When the recording medium 10 is inserted in the superordinate apparatus 20 (step S101), the install processing is started with the use of the recording medium 10 (step S102). The subsequent install processing will be performed based on the control by the installation control portion 11.

Upon start of the processing, the install processing of the printer driver 14a is performed (step S103). If this install processing has been done normally, the install processing of the firmware is subsequently started.

During the firmware install processing, it is first determined whether the name of the folder to store the firmware is to be changed or not (step S104), and it is then determined whether the location to store the firmware is to be changed or not (step S106). During this operation, the screen illustrated in FIG. 4 is displayed.

If it is determined that the firmware is to be installed with the default setting unchanged (NO in step S104 and then NO in step S106), the firmware installation is started directly (step S108). In contrast, if the name of the folder to store the firmware is changed (YES in step S104), the folder name is changed from the default to the user's desired folder name by the firmware storage location indicating portion 11a (step S105).

If the location to store the firmware is changed (YES in step S106), the storage location is changed from the default to the user's desired storage location by the firmware storage location indicating portion 11a (step S107). The folder name and/or the storage location changed here are/is stored in the firmware storage location holding portion 12.

When the firmware 14b has been installed in the desired storage location (step S108), the processing terminates.

According to the present invention as described above, the installation of the firmware 14b is controlled in association with the installation of the printer driver 14a so that the printer driver 14a and the firmware 14b can be installed at the same time. This eliminates the need of troublesome operation of installing them separately, and also avoids the problem that the storage location of the firmware 14b cannot be found and the printer 30 cannot be activated.

Further, according to the present invention, the folder to store the firmware 14b can be set as required. Therefore, the present invention solves the problem posed by the conventional techniques that it is difficult to know what role a specific folder plays from its default name or storage location.

It is also possible to perform an operation linking the two programs, the firmware 14b and the printer driver 14a together, such as to check the storage location of the firmware 14b from the printer driver 14a. Therefore, the storage location of the firmware 14b can be known easily even after the installation thereof.

Even if there occurs a trouble in either of these programs or either of these programs is to be upgraded after installation thereof, the latest versions of both the printer driver 14a and the firmware 14b can be installed simultaneously to maintain the consistency between them. Therefore, it is possible to avoid a problem due to the non-consistency between versions of the two programs.

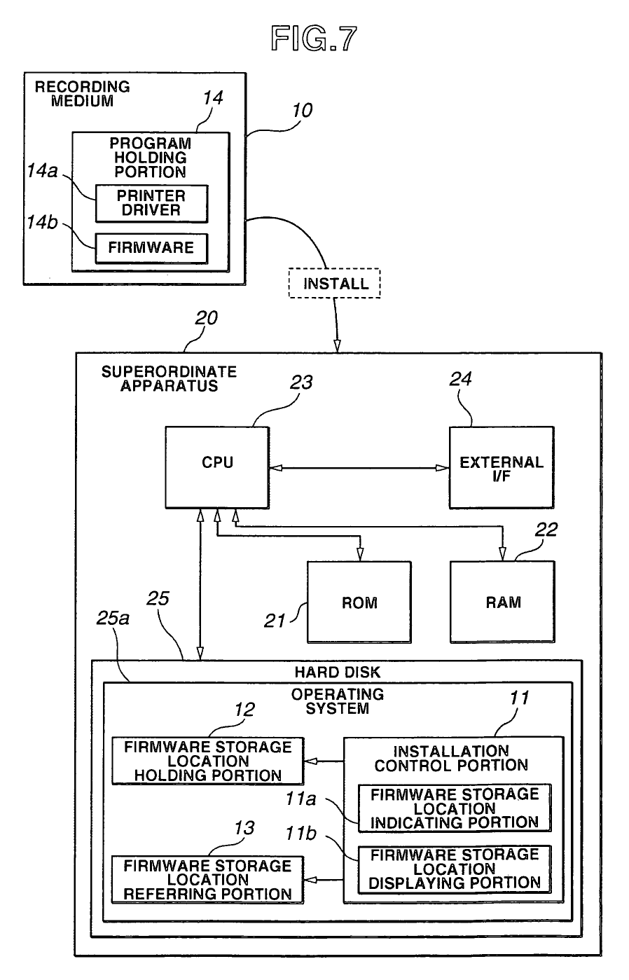

Description will now be made of a modification of the embodiment above, with reference to FIG. 7. FIG. 7 also shows the recording medium 10 and the superordinate apparatus 20 as described with reference to FIG. 2. Those components assigned with the same reference numerals as those in FIG. 2 operate substantially in the same manner.

A recording medium 10 has a program holding portion 14 in which a printer driver 14a and firmware 14b are recorded. That is, the printer driver 14a and the firmware 14b are recorded on a same medium.

A superordinate apparatus 20 includes an ROM 21, an RAM 22, a CPU 23, an external I/F 24, and a hard disk 25. The hard disk 25 is provided with an install program (installer) which is operated by an operating system 25a, or basic software for operating the superordinate apparatus 20.

The install program includes, as processing functional portions, an installation control portion 11 having a firmware storage location indicating portion 11a and a firmware storage location displaying portion 11b, a firmware storage location holding portion 12, and a firmware storage location referring portion 13. This means that, according to this modified embodiment, these processing functions, which are provided in the recording medium 10 according to the first embodiment above, are instead provided in the superordinate apparatus 20 as the install program to perform the install processing of the present invention.

According to this configuration, when the recording medium 10 having the printer driver 14a and firmware 14b recorded therein is inserted into the superordinate apparatus 20, the install processing of the firmware 14b is performed along with the installation of the printer driver 14a by the control of the installation control portion 11, in the same manner as in the first embodiment above.

Accordingly, so far as a recording medium has the printer driver 14a and the firmware 14b recorded together, such recording medium can be used to realize the install processing according to the present invention.

It should be understood that the present invention is not limited to the embodiments described above and illustrated in the attached drawings, but may be otherwise variously embodied without departing from the spirit and scope of the invention.

The printer system, the recording medium and the install method according to the present invention are applicable to printer systems in general having a printer (image forming apparatus) that operates by acquiring firmware from a superordinate apparatus, and are particularly capable of facilitating the installation of the printer driver and the firmware.

As described above, according to an aspect of the present invention, a printer system comprises a superordinate apparatus in which a printer driver and firmware are installed; a printer that downloads the firmware from the superordinate apparatus to store the same in a memory, the printer being controlled based on the firmware stored in the memory, wherein the superordinate apparatus comprises an install controller that controls installation of the firmware in association with installation of the printer driver.

According to another aspect of the present invention, in the printer system according to the first-mentioned aspect of the present invention, the install controller comprises a storage location indicating portion that indicates, when the firmware is installed, a storage location of the firmware in the superordinate apparatus where the firmware is stored after being installed in the superordinate apparatus; and a storage location displaying portion that displays the storage location of the firmware indicated by the storage location indicating portion, on a display of the superordinate apparatus.

According to still another aspect of the present invention, in the printer system according to the another aspect of the present invention, the install controller further comprises a firmware storage location holding portion that stores and holds the storage location of the firmware indicated by the storage location indicating portion; and a firmware storage location referring portion that presents the storage location of the firmware, the firmware storage location referring portion displaying the storage location of the firmware on a property screen of the printer driver.

According to yet another aspect of the present invention, in the printer system according to the first-mentioned aspect of the present invention, the install controller uses a recording medium on which the printer driver and the firmware are recorded together to install the printer driver and the firmware.

According to even another aspect of the present invention, a recording medium records thereon a printer driver and firmware to be installed in a superordinate apparatus of a printer system are recorded, the printer system comprising the superordinate apparatus in which the printer driver and the firmware are to be installed; a printer that downloads the firmware from the superordinate apparatus to store the same in a memory, and is controlled based on the firmware stored in the memory, the printer driver and the firmware being recorded together in the recording medium, the recording medium having recorded therein an install program comprising an install control step of controlling installation of the firmware in association with installation of the printer driver; a storage location indicating step of indicating a storage location of the firmware in the superordinate apparatus where the firmware is stored after being installed in the superordinate apparatus; and a storage location displaying portion step of displaying the storage location of the firmware indicated by the storage location indicating step, on a display of the superordinate apparatus.

According to even still another aspect of the present invention, in the recording medium according to even another aspect of the present invention, the install control step further comprises a firmware storage location holding step of storing and holding the storage location of the firmware indicated by the storage location indicating step; and a firmware storage location referring step of presenting the storage location of the firmware, the firmware storage location referring step displaying the storage location of the firmware on a property screen of the printer driver.

According to even yet another aspect of the present invention, in an install method of installing a printer driver and firmware in a superordinate apparatus of a printer system, the printer system comprising the superordinate apparatus in which the printer driver and the firmware are to be installed a printer that downloads the firmware from the superordinate apparatus to store the same in a memory, and is controlled based the firmware stored in the memory, the install method comprises controlling, by an install controller, installation of the firmware in association with installation of the printer driver in the superordinate apparatus; indicating, by a storage location indicating portion, a firmware storage location in the superordinate apparatus where the firmware is stored after being installed in the superordinate apparatus; and displaying, by a storage location displaying portion, the firmware storage location indicated by the storage location indicating portion, on a display of the superordinate apparatus.

The forgoing description of the embodiment of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

The entire disclosure of Japanese Patent Application No. 2005-12818 filed on Jan. 20, 2005 including specification, claims, drawings and abstract is incorporated herein by reference in its entirety.

What is claimed is:

1. A printer system comprising:
a superordinate apparatus in which a printer driver and firmware are installed;
a printer that downloads the firmware from the superordinate apparatus to store the same in a memory, the printer being controlled based on the firmware stored in the memory,
wherein the superordinate apparatus comprises an install controller that controls installation of the firmware in association with installation of the printer driver.

2. The printer system according to claim 1, wherein the install controller comprises:
a storage location indicating portion that indicates, when the firmware is installed, a storage location of the firmware in the superordinate apparatus where the firmware is stored after being installed in the superordinate apparatus; and
a storage location displaying portion that displays the storage location of the firmware indicated by the storage location indicating portion, on a display of the superordinate apparatus.

3. The printer system according to claim 2, wherein the install controller further comprises:
a firmware storage location holding portion that stores and holds the storage location of the firmware indicated by the storage location indicating portion; and
a firmware storage location referring portion that presents the storage location of the firmware,
the firmware storage location referring portion displaying the storage location of the firmware on a property screen of the printer driver.

4. The printer system according to claim 1, wherein the install controller uses a recording medium on which the printer driver and the firmware are recorded together to install the printer driver and the firmware.

5. A recording medium on which a printer driver and firmware to be installed in a superordinate apparatus of a printer system are recorded, the printer system comprising:
the superordinate apparatus in which the printer driver and the firmware are to be installed;
a printer that downloads the firmware from the superordinate apparatus to store the same in a memory, and is controlled based on the firmware stored in the memory,
the printer driver and the firmware being recorded together in the recording medium,
the recording medium having recorded therein an install program comprising:
an install control step of controlling installation of the firmware in association with installation of the printer driver;
a storage location indicating step of indicating a storage location of the firmware in the superordinate apparatus where the firmware is stored after being installed in the superordinate apparatus; and
a storage location displaying portion step of displaying the storage location of the firmware indicated by the storage location indicating step, on a display of the superordinate apparatus.

6. The recording medium according to claim 5, wherein the install control step further comprises:
a firmware storage location holding step of storing and holding the storage location of the firmware indicated by the storage location indicating step; and
a firmware storage location referring step of presenting the storage location of the firmware,
the firmware storage location referring step displaying the storage location of the firmware on a property screen of the printer driver.

7. An install method of installing a printer driver and firmware in a superordinate apparatus of a printer system, the printer system comprising:
the superordinate apparatus in which the printer driver and the firmware are to be installed;
a printer that downloads the firmware from the superordinate apparatus to store the same in a memory, and is controlled based the firmware stored in the memory,
the install method comprising:
controlling, by an install controller, installation of the firmware in association with installation of the printer driver in the superordinate apparatus;
indicating, by a storage location indicating portion, a firmware storage location in the superordinate apparatus where the firmware is stored after being installed in the superordinate apparatus; and
displaying, by a storage location displaying portion, the firmware storage location indicated by the storage location indicating portion, on a display of the superordinate apparatus.
